(19) United States
(12) Patent Application Publication
(10) Pub. No.: US 2010/0154740 A1
(43) Pub. Date: Jun. 24, 2010

(54) VARIABLE VALVE TIMING MECHANISM CONTROL APPARATUS AND CONTROL METHOD

(75) Inventor: Yasuhiro Mitsuishi, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 12/601,152

(22) PCT Filed: May 21, 2008
(86) PCT No.: PCT/IB08/01658

§ 371 Date: Nov. 20, 2009

(30) Foreign Application Priority Data
May 21, 2007 (JP) 2007-134288

(51) Int. Cl. F02D 13/00; F01L 1/34

(52) U.S. Cl. 123/347; 123/90.15

(57) ABSTRACT

A variable valve timing mechanism control apparatus which enables a valve timing of an intake valve of an internal combustion engine and a valve timing of an exhaust valve of the internal combustion engine to be varied individually, prohibits a change in the valve timing of the intake valve and changes only the valve timing of the exhaust valve when a valve overlap amount is negative. As a result, the required ignition timing will not change in a complex manner in the region where the valve overlap amount is negative so the ignition timing can be easily optimized even when the valve overlap amount is negative.

### BACKGROUND OF THE INVENTION

1. Field of the Invention

The invention relates to a variable valve timing mechanism control apparatus and control method which can vary the valve timing of an intake valve and the valve timing of an exhaust valve individually.

2. Description of the Related Art

One known mechanism provided in an internal combustion engine of a vehicle or the like is a variable valve timing mechanism that varies the timing at which engine valves (i.e., intake and exhaust valves) open and close, i.e., the valve timing. In an internal combustion engine having a variable valve timing mechanism, pumping loss and exhaust gas emissions and the like can be reduced by adjusting the valve overlap amount of the intake and exhaust valves according to the operating state of the engine.

Japanese Patent Application Publication No. 2005-83281 (JP-A-2005-83281), Japanese Patent Application Publication No. 2002-349301 (JP-A-2002-349301), and Japanese Patent Application Publication No. 10-331670 (JP-A-10-331670) each propose a control apparatus for such a variable valve timing mechanism. The control apparatus described in JP-A-2005-83281 reduces the operating speed of the variable valve timing mechanism under operating conditions in which the valve overlap amount significantly affects the amount of fuel that adheres to the wall surface of the intake port, such as at low temperatures. This inhibits the valve overlap amount from suddenly changing, thereby preventing the air-fuel ratio from becoming overly lean from a sudden increase in the amount of fuel that adheres to the wall surface of the intake port. Also, the control apparatuses described in JP-A-2002-349301 and JP-A-10-331670 inhibit a decrease in torque caused by an increase in the internal EGR amount or an increase in the amount of fuel that adheres to the wall surface of the intake port, which occurs due to a sudden increase in the valve overlap amount, by keeping the rate of change in the valve timing lower when increasing the valve overlap amount than when decreasing the valve overlap amount.

The valve overlap amount of the intake and exhaust valves will now be described. The valve overlap amount is defined here as the crank angle from the timing at which the intake valve opens to the timing at which the exhaust valve closes, or more precisely, the difference value of the crank angle when the exhaust valve closes minus the crank angle when the intake valve opens. For example, in the state shown in FIG. 13A, the exhaust valve closes after the intake valve has opened so there is a period of valve overlap during which both of the valves are open between the timing at which the intake valve opens and the timing at which the exhaust valve closes. Thus, according to the definition above, the valve overlap amount at this time is a positive value. Also, in the state shown in FIG. 13B, the intake valve opens at the same time the exhaust valve closes so the value of the valve overlap at this time is 0. On the other hand, in the state shown in FIG. 13C, the intake valve is opened after the exhaust valve has closed so there is a period during which both of the valves are closed between the timing at which the exhaust valve closes and the timing at which the intake valve opens. Thus, according to the definition above, the amount of valve overlap at this time is a negative value.

In a typical internal combustion engine, the valve characteristics are almost never set so that the valve overlap amount is a negative value. However, in an internal combustion engine in which the exhaust valve is closed early (i.e., in which the closing timing of the exhaust valve is advanced), as described below, the valve overlap amount may be negative. This early closing of the exhaust valve is performed as follows. First, the closing timing of the exhaust valve is advanced approximately 20° CA from top dead center (TDC) of the exhaust stroke. As a result, some burned gas remains in the cylinder where it is compressed again, which raises its temperature. Then when the intake valve opens, this high temperature burned gas flows back into the intake port where it promotes the atomization of fuel adhered to the wall surface of the intake port. The valve timing of the intake and exhaust valves at this time is set so that the valve overlap amount is negative, as shown in FIG. 13C, for example. The closing timing of the exhaust valve is able to be advanced in this way by providing a variable valve timing mechanism on both the intake side and the exhaust side.

When the valve overlap amount is negative, the amount of burned gas remaining in the cylinder changes greatly depending on the closing timing of the exhaust valve and the amount of valve overlap. If a large amount of burned gas remains in the cylinder, combustion becomes slows so the MBT (Minimum Advance for Best Torque) point of the ignition timing advances. Also, when the valve overlap amount is negative, the compression end temperature also changes depending on the closing timing of the exhaust valve and the amount of valve overlap. Because knock tends to occur when the compression end temperature is high, the knock limit point of the ignition timing is retarded. Therefore, when the valve overlap amount is negative, the required ignition timing, which is determined by the MBT point and the knock limit point of the ignition timing, greatly changes depending on the closing timing of the exhaust valve and the amount of valve overlap.

FIG. 14 shows the manner of change in the required ignition timing according to the valve overlap amount and the valve timing of the intake valve in the low load region of the internal combustion engine, where the required ignition timing is determined by the MBT timing. Incidentally, the valve timing of the intake valve is indicated here by the advance amount [°] of the valve timing, with the most retarded position of the valve timing variable range being the reference [0°]. As shown in the drawing, in the region where the valve overlap amount is negative, the required ignition timing rapidly advances as the valve overlap amount decreases.

FIG. 15 shows the manner of change in the required ignition timing according to the valve overlap amount and the valve timing of the intake valve in the high load region of the internal combustion engine, where the required ignition timing is determined by the knock limit point. As shown in the drawing, in the region where the valve overlap amount is negative, the required ignition timing rapidly retards as the valve overlap amount decreases.

When the valve overlap amount is negative in this way, the required ignition timing greatly changes according to changes in the closing timing of the exhaust valve and the valve overlap amount. Therefore, when changing the valve timing of the intake and exhaust valves while the valve overlap amount is negative, the ignition timing must be adjusted according to the changes in the valve timing and the valve overlap amount. However, the required ignition timing is such that it will not become constant when the valve overlap amount is negative, even if the valve overlap amount or the valve timing of the exhaust valve is constant. Also, when variable valve timing mechanisms of the intake and exhaust sides are operated simultaneously, variation in the operating speeds of the two mechanisms causes the valve overlap amount to change in a complex manner while the mechanisms are operating. As a result, the change in the required ignition timing while the valve timing of the intake and exhaust valves is in the process of changing when the valve overlap amount is negative becomes difficult to predict. Therefore, when changing the valve overlap amount from positive to negative or from negative to positive, the ignition timing is no longer able to be adjusted according to the change in the required ignition timing which corresponds to changes in the valve timing and the valve overlap amount, and as a result, torque generating efficiency may decline and knocking may occur.

Incidentally, all of the technologies described in the foregoing publications presume valve timing control with a valve overlap amount that is either 0 or positive. No particular reference is made to valve timing control while the valve overlap amount is negative.

### SUMMARY OF THE INVENTION

This invention thus provides a variable valve timing mechanism control apparatus and control method capable of easily optimizing the ignition timing even when the valve overlap amount is negative.

A first aspect of the invention relates to a variable valve timing mechanism control apparatus which enables a valve timing of an intake valve of an internal combustion engine and a valve timing of an exhaust valve of the internal combustion engine to be varied individually. This control apparatus is provided with a controller which controls the variable valve timing mechanism in such a manner as to prohibit a change in the valve timing of one valve, from among the intake valve and the exhaust valve, and change the valve timing of the other valve when a valve overlap amount is negative.

With this structure, only the valve timing of one valve, i.e., either the intake valve or the exhaust valve, is changed in the region where the valve overlap amount is negative. This makes it possible to prevent the required ignition timing from changing in a complex manner even in the region where the valve overlap amount is negative. Therefore, this structure makes it easy to optimize the ignition timing even when the valve overlap amount is negative.

With the foregoing structure, the controller may control the variable valve timing mechanism in such a manner as to prohibit a change in the valve timing of the intake valve when the valve overlap amount is negative.

Incidentally, with the foregoing structure, the controller may prohibit a change in the valve timing of the intake valve when the valve overlap amount is negative by restricting the amount of change in the valve timing of the intake valve when changing the valve overlap amount from negative to positive. More specifically, the controller may fix the valve timing of the intake valve and change only the valve timing of the exhaust valve when the valve overlap amount is less than 0, and start to change the valve timing of the intake valve when the valve overlap amount is equal to or greater than 0.

Also, with the foregoing structure, the controller may prohibit a change in the valve timing of the intake valve when the valve overlap amount is negative by restricting the amount of change in the valve timing of the exhaust valve when changing the valve overlap amount from positive to negative. More specifically, the controller may restrict the amount of change in the valve timing of the exhaust valve such that the valve overlap amount is kept equal to or greater than 0, until the change in the valve timing of the intake valve is complete.

Moreover, the controller may cancel the restriction on the amount of change in the valve timing of the exhaust valve when the internal combustion engine is suddenly decelerating.

With this structure, the valve timing of both the intake and exhaust valves can be changed without being restricted during sudden deceleration so the valve timing of the intake and exhaust valves can be changed as quickly as possible. Accordingly, even if the internal combustion engine is stopped immediately after suddenly decelerating, the valve timing of the intake and exhaust valves can be placed in a state that can ensure good startability the next time the internal combustion engine is started up.

With the foregoing structure, the controller may perform, on the variable valve timing mechanism, feedback control which sets a target intake valve timing and a target overlap amount, changes the valve timing of the intake valve to the target intake valve timing, and changes the valve timing of the exhaust valve such that the overlap amount comes to match the target overlap amount.

In the foregoing structure, the controller may calculate the target intake valve timing and the target overlap amount based on at least one of a speed of the internal combustion engine and an intake air amount of the internal combustion engine.

In the foregoing structure, the controller may perform control which prohibits a change in the valve timing of one valve, from among the intake valve and the exhaust valve, and changes only the valve timing of the other valve during at least one of startup of the internal combustion engine and idling of the internal combustion engine.

A second aspect of the invention relates to a variable valve timing mechanism control method which enables a valve timing of an intake valve of an internal combustion engine and a valve timing of an exhaust valve of the internal combustion engine to be varied individually. This control method includes prohibiting a change in the valve timing of one valve, from among the intake valve and the exhaust valve, and changing only the valve timing of the other valve when a valve overlap amount is negative.

### BRIEF DESCRIPTION OF THE DRAWINGS

The foregoing and further objects, features and advantages of the invention will become apparent from the following description of embodiments with reference to the accompanying drawings, wherein like numerals are used to represent like elements and wherein:

FIG. 1 is a perspective view of the structure of a variable valve timing mechanism according to a first example embodiment of the invention, together with a block diagram of the control system of that variable valve timing mechanism;

FIG. 2 is a chart showing the manner of change in the valve timing of the intake and exhaust valves according to the first example embodiment;

FIG. 3 is a chart showing the initial state of the valve timing of the intake and exhaust valves according to the first example embodiment;

FIG. 4 is a time chart showing a valve timing control mode when the valve overlap amount changes from negative to positive in the first example embodiment;

FIGS. 5A, 5B, 5C, and 5D are charts showing the shift in the valve timing of the intake and exhaust valves when the valve overlap amount changes from negative to positive in the first example embodiment;

FIG. 6 is a time chart showing a valve timing control mode when the valve overlap amount changes from positive to negative in the first example embodiment;

FIGS. 7A, 7B, 7C, and 7D are charts showing the shift in the valve timing of the intake and exhaust valves when the valve overlap amount changes from negative to positive in the first example embodiment;

FIG. 8 is a graph showing the shift in the required ignition timing when the valve overlap amount changes from negative to positive, and from positive to negative, in the low load region of an internal combustion engine in the first example embodiment;

FIG. 9 is a graph showing the shift in the required ignition timing when the valve overlap amount changes from negative to positive, and from positive to negative, in the high load region of the internal combustion engine in the first example embodiment;

FIG. 10 is a time chart showing a valve timing control mode during sudden deceleration in the first example embodiment;

FIGS. 11A, 11B, and 11C are charts showing the shift in the valve timing of the intake and exhaust valves during sudden deceleration in the first example embodiment;

FIG. 12 is a flowchart illustrating a valve timing control routine applied to the first example embodiment;

FIGS. 13A, 13B, and 13C are charts showing the valve timing of the intake and exhaust valves when the valve overlap amount is positive, 0, and negative, respectively;

FIG. 14 is a graph showing an example of the manner in which the required ignition timing changes with respect to the intake valve timing and the valve overlap amount in the low load region of the internal combustion engine; and

FIG. 15 is a graph showing an example of the manner in which the required ignition timing changes with respect to the intake valve timing and the valve overlap amount in the high load region of the internal combustion engine.

### DETAILED DESCRIPTION OF THE EMBODIMENTS

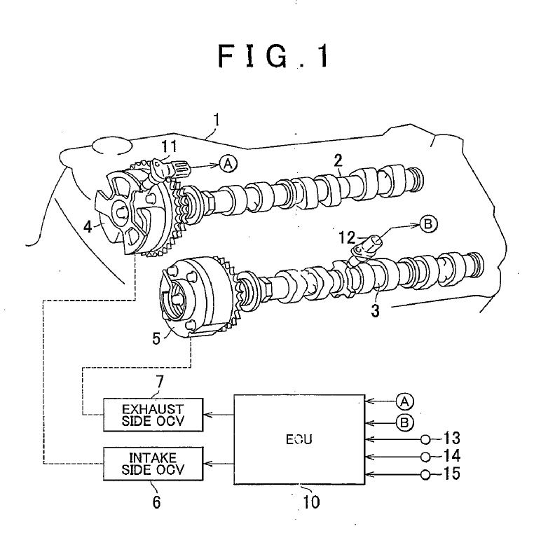

Hereinafter, an example embodiment of the variable valve timing mechanism control apparatus of invention will be described in detail with reference to FIGS. 1 to 12. The variable valve timing mechanism control apparatus according to this example embodiment prohibits the valve timing of the intake valve from changing when the valve overlap amount is negative by restricting the amount of change in the valve timing of the intake valve or the exhaust valve while the valve overlap amount is in the process of changing from negative to positive or from positive to negative. As a result, the change in the required ignition timing when the valve overlap amount is negative will not become complex so the ignition timing can easily be adjusted while the valve overlap amount is in the process of changing between positive and negative.

FIG. 1 shows the overall structure of this example embodiment. As shown in the drawing, an intake camshaft 2 on which are provided intake cams that open and close intake valves, and an exhaust camshaft 3 on which are provided exhaust cams that open and close exhaust valves, are rotatably supported by a cylinder head of an internal combustion engine 1. An intake side variable valve timing mechanism 4 is provided on an end portion of the intake camshaft 2, and an exhaust side variable valve timing mechanism 5 is provided on an end portion of the exhaust camshaft 3. These variable valve timing mechanisms 4 and 5 are operated by hydraulic pressure, and change the valve timing of the intake valves and exhaust valves by changing the relative rotation phases of the intake camshaft 2 and the exhaust camshaft 3 with respect to a crankshaft that serves as the engine output shaft.

Operation of these variable valve timing mechanisms 4 and 5 is controlled by an electronic control unit (hereinafter simply referred to as “ECU”) 10 that is responsible for engine control (this electronic control unit corresponds to the controller of the invention). The ECU 10 includes a central processing unit (CPU) that executes various computations and processing related to engine control, read-only memory (ROM) in which control programs and data are stored, random access memory (RAM) that temporarily stores the computation results and the like from the CPU, and input/output ports that send and receive signals to and from other components.

Various sensors are connected to the input port of the ECU 10. These sensors include an intake side cam angle sensor 11 that detects the rotation phase of the intake camshaft 2 (i.e., the intake cam angle), an exhaust side cam angle sensor 12 that detects the rotation phase of the exhaust camshaft 3 (i.e., the exhaust cam angle), and a crank angle sensor 13 that detects the rotation phase of the crankshaft (i.e., the crank angle). The ECU 10 detects the valve timing of the intake and exhaust valves from detection signals indicative of the intake cam angle, the exhaust cam angle, and the crank angle, which are output by these sensors (11 to 13). The ECU 10 also detects the speed of the internal combustion engine 1 (i.e., the engine speed NE) from a detection signal output by the crank angle sensor 13. Incidentally, various sensors and meters and the like which detect the operating state of the engine are also connected to the input port of the ECU 10. These sensors and meters include an airflow meter 14 that detects the intake air amount GA of the internal combustion engine 1, and an accelerator sensor 15 that detects the operating amount of an accelerator pedal (i.e., accelerator pedal operating amount ACCP).

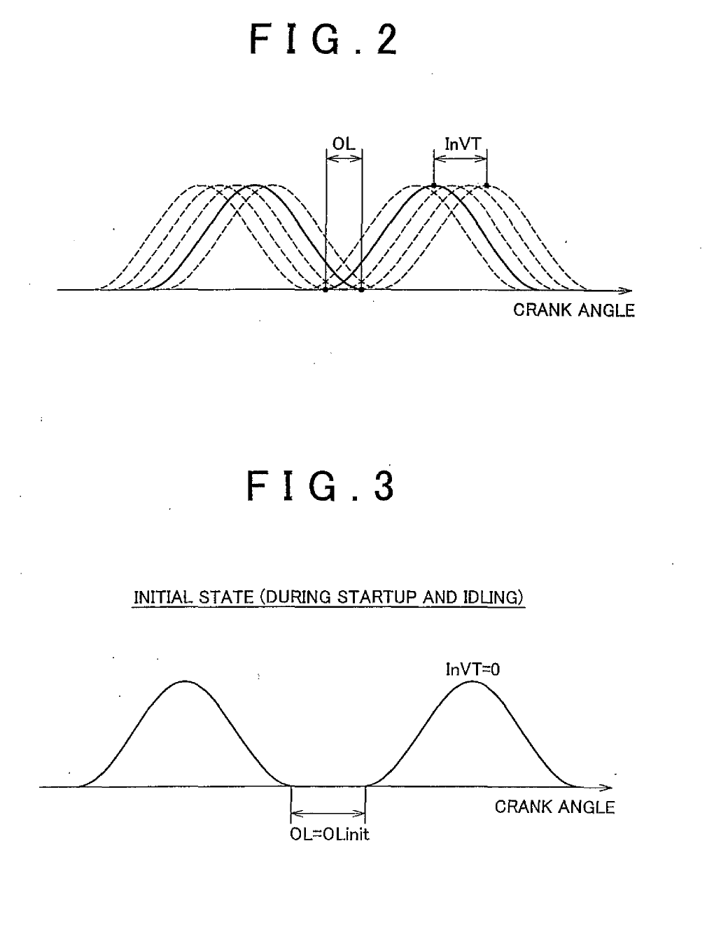

Meanwhile, an intake side hydraulic control valve (OCV) 6 that adjusts the hydraulic pressure of the intake side variable valve timing mechanism 4, and an exhaust side hydraulic control valve (OCV) 7 that adjusts the hydraulic pressure of the exhaust side variable valve timing mechanism 5 are connected to the output port of the ECU 10. The ECU 10 variably controls the valve timing of the intake and exhaust valves individually by controlling the operation of the variable valve timing mechanisms 4 and 5 through control of these hydraulic control valves 6 and 7. FIG. 2 shows the manner of change in the valve timing of the intake and exhaust valves according to these variable valve timing mechanisms 4 and 5.

The valve timing control of the intake and exhaust valves by the ECU 10 is basically performed in the following manner. That is, the ECU 10 calculates a target overlap amount OLT, which is a target value for the valve overlap amount, and a target intake valve timing InVTT, which is a target value for the valve timing of the intake valve, based on the engine speed NE and the intake air amount GA and the like using an operation map stored in the ROM. Then the ECU 10 controls, through feedback-control, the operation of the intake side variable valve timing mechanism 4 so that the actual valve timing of the intake valve (i.e., the actual intake valve timing InVT) ultimately comes to match the target intake valve timing InVTT. Meanwhile, the ECU 10 controls, through feedback-control, the operation of the exhaust side variable valve timing mechanism 5 so that the actual valve overlap amount (i.e., the actual overlap amount OL) ultimately comes to match the target overlap amount OLT. In this way, the valve timing of the intake and exhaust valves and valve overlap amount are adjusted to the optimum values for the operating state of the engine.

Incidentally, with the control apparatus according to this example embodiment, the valve timing of the intake valve is indicated by the valve timing advance amount (i.e., the crank angle [°]), with the most retarded position of the range through which the valve timing of the intake valve can be changed (hereinafter this range will be referred to simply as the “variable range”) being the reference 0° . Also, the valve overlap amount is defined as the difference value of the crank angle when the exhaust valve closes minus the crank angle when the intake valve opens. Therefore, when the exhaust valve is closed before the intake valve is opened such that there is a period during which both of the valves are closed between the timing at which the exhaust valve closes and the timing at which the intake valve opens, the valve overlap amount becomes a negative value.

The control apparatus according to this example embodiment closes the exhaust valve early when the internal combustion engine 1 is starting up and idling. At this time, the valve overlap amount becomes a negative value. The valve timing of the intake and exhaust valves at this time is set as shown in FIG. 3. That is, the valve timing of the intake valve at this time (i.e., the actual intake valve timing InVT) is set to 0° which is the most retarded position. Also, the valve overlap amount at this time (i.e., the actual overlap amount OL) is set to an initial value OLinit (<0) which is the minimum value of the variable range. As a result, the closing timing of the exhaust valve is advanced approximately 20° CA from top dead center (TDC) of the exhaust stroke such that some burned gas remains in the cylinder where it is compressed again, which raises its temperature. Then when the intake valve opens, this high temperature burned gas flows back into the intake port where it promotes the atomization of fuel adhered to the wall surface of the intake port. Incidentally, in the internal combustion engine 1 to which this example embodiment is applied, at times other than during startup and idling, the valve timing is set so that the valve overlap amount is 0 or positive.

As described above, in this example embodiment, the amount of change in the valve timing of the intake valve or the exhaust valve is restricted when the valve overlap amount is in the process of changing from negative to positive or from positive to negative, and the valve timing of the intake valve is prohibited from changing when the valve overlap amount is negative. The valve timing control when the valve overlap amount is in the process of changing between positive and negative of this example embodiment will now be described in detail.

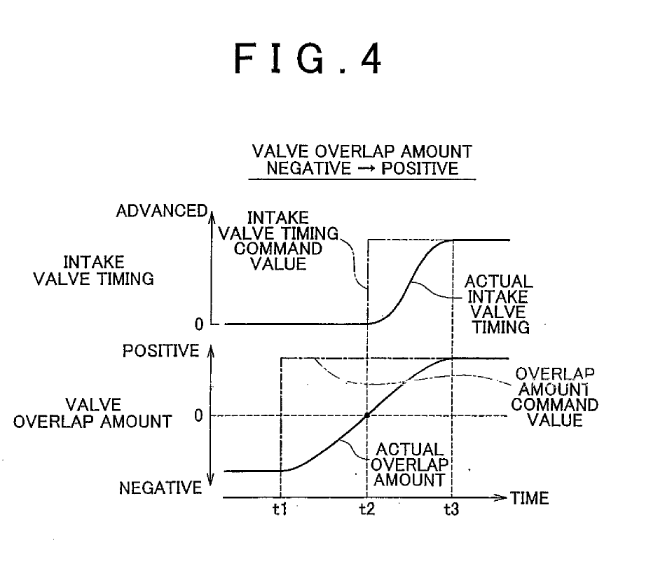

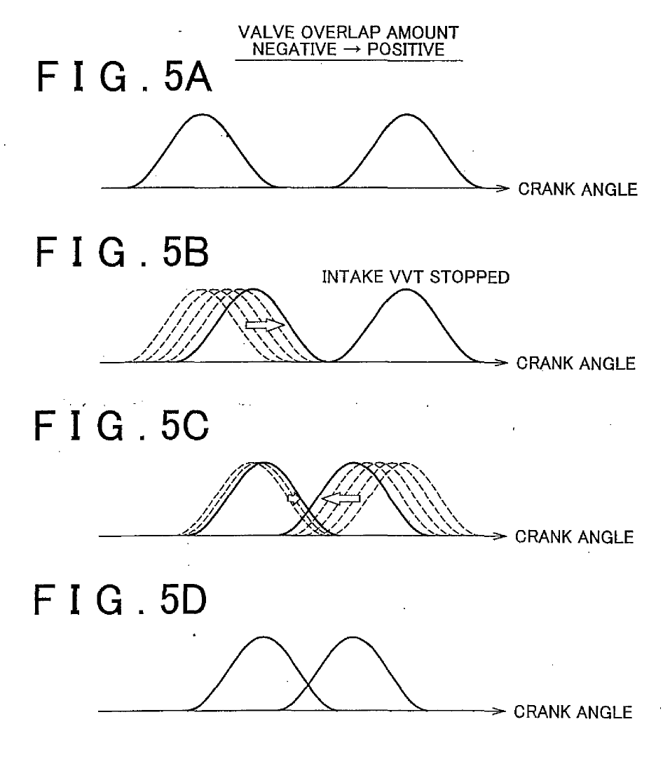

First, the valve timing control when the valve overlap amount is in the process of changing from negative to positive will be described. FIG. 4 shows the changes in the command value and the actual value of the intake valve timing, and the command value and the actual value of the valve overlap amount at this time. This drawing shows the changes in each of these parameters when the valve overlap amount is changed from a negative state (shown in FIG. 5A) to a positive state (shown in FIG. 5D). Incidentally, in the state shown in FIG. 5A, the actual intake valve timing InVT is the most retarded position)(0° and the actual overlap amount OL is the initial value OLinit.

First, at time t1 when the valve overlap amount starts to change from negative to positive, the ECU 10 sets only the overlap amount command value tOL to the final target value corresponding to the operating state of the engine while keeping the intake valve timing command value tInVT at 0° . Then at time t2 when the actual overlap amount OL reaches 0, the ECU 10 sets the intake valve timing command value tInVT to the final target value corresponding to the operating state of the engine.

Therefore, during the period from time tl when the valve overlap amount starts to change from negative to positive until time t2 when the actual valve overlap amount is 0, only the valve timing of the exhaust valve is changed while the valve timing of the intake valve remains fixed at 0° , so the actual overlap amount OL increases, as shown in FIG. 5B. Then during the period from time t2 until time t3 which is when the valve overlap amount finishes changing to positive, the valve timing of the intake valve is changed, as shown in FIG. 5C.

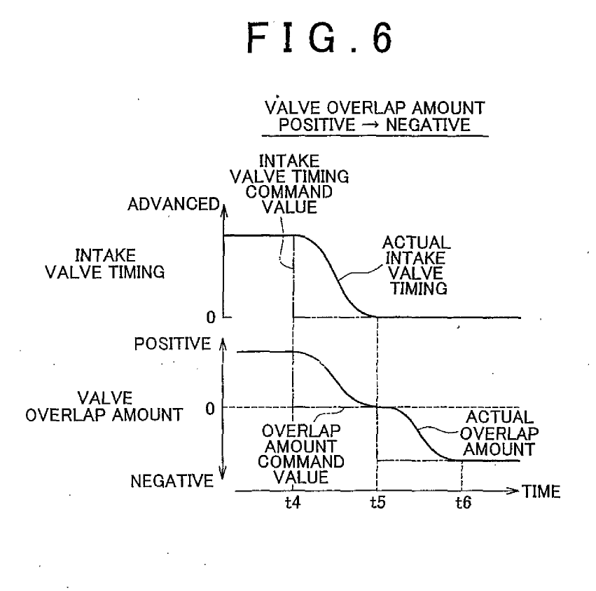

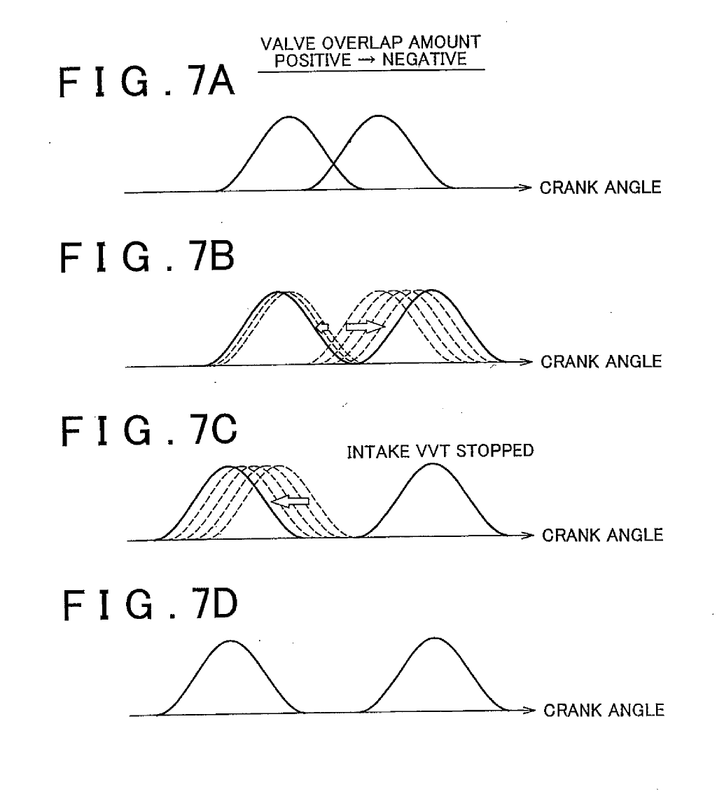

Next, the valve timing control when the valve overlap amount is in the process of changing from positive to negative will be described. FIG. 6 shows the changes in the command value and the actual value of the intake valve timing, and the command value and the actual value of the valve overlap amount at this time. This drawing shows the changes in each of these parameters when the valve overlap amount is changed from a positive state (shown in FIG. 7A) to a negative state (shown in FIG. 7D). Incidentally, in the state shown in FIG. 7D, the actual intake valve timing InVT is the most retarded position)(0° and the actual overlap amount OL is the initial value OLinit.

First, at time t4 when the valve overlap amount starts to change from positive to negative, the ECU 10 sets the intake valve timing command value tInVT to the most retarded position 0° , which is its final target value. However, at this time, the overlap amount command value tOL is set to 0 instead of the initial value OLinit, which is its final target value. Then at time t5 when the actual intake valve timing InVT becomes 0° and the valve timing of the intake valve has finished changing, the ECU 10 sets the overlap amount command value tOL to the initial value OLinit, which is its final target value.

Therefore, during the period from time t4 when the valve overlap amount starts to change from positive to negative until time t5 when the valve timing of the intake valve finishes changing, the amount of change in the valve timing of the exhaust valve is restricted to within a range that keeps the actual overlap amount OL equal to or greater than 0, as shown in FIG. 7B. Then, during the period from time t5 to time t6 which is when the valve overlap amount finishes changing to negative, only the valve timing of the exhaust valve is changed while the valve timing of the intake valve remains fixed, as shown in FIG. 7C.

In this way, in this example embodiment, when the actual overlap amount OL is negative when the valve overlap amount changes either from negative to positive or from positive to negative, the valve timing of the intake valve is prohibited from changing and only the valve timing of the exhaust valve is changed. As a result, the change in the required ignition timing when the valve overlap amount is negative is simple and can thus be predicted.

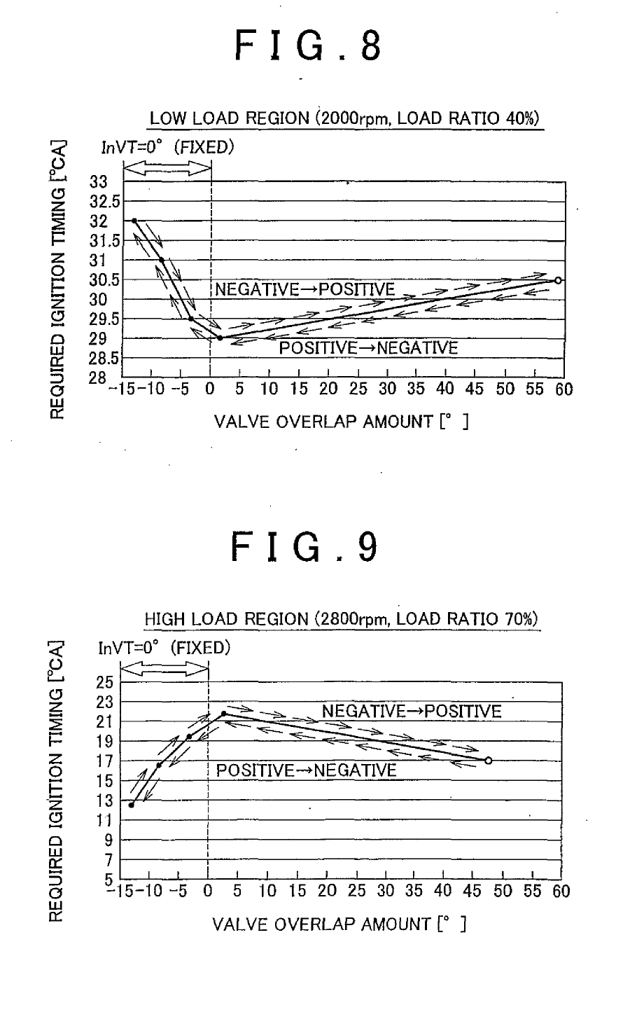

FIG. 8 is a graph showing the shift in the required ignition timing when the valve overlap amount changes from negative to positive, and from positive to negative, in the low load region of the internal combustion engine 1. Also, FIG. 9 is a graph showing the shift in the required ignition timing when the valve overlap amount changes from negative to positive, and from positive to negative, in the high load region of the internal combustion engine 1. As described above, in this example embodiment, only the valve timing of the exhaust valve is changed when the valve overlap amount is negative. Therefore, as shown in these drawings, regardless of whether the engine is operating in the low load region or the high load region, the change in the required ignition timing in the region where the valve overlap amount is negative is uniform (i.e., monotonic) so the ignition timing can be easily adjusted.

Incidentally, in this example embodiment, the only time that the amount of change in the valve timing of the exhaust valve is not restricted while the valve overlap amount is in the process of changing from positive to negative as described above, is when the internal combustion engine 1 is suddenly decelerating. That is, when a command is output to change the valve overlap amount from positive to negative while the internal combustion engine 1 is suddenly decelerating, the intake valve timing command value tInVT and the overlap amount command value tOL are both set to their final target values at time t7, which is when the change command is output, as shown in

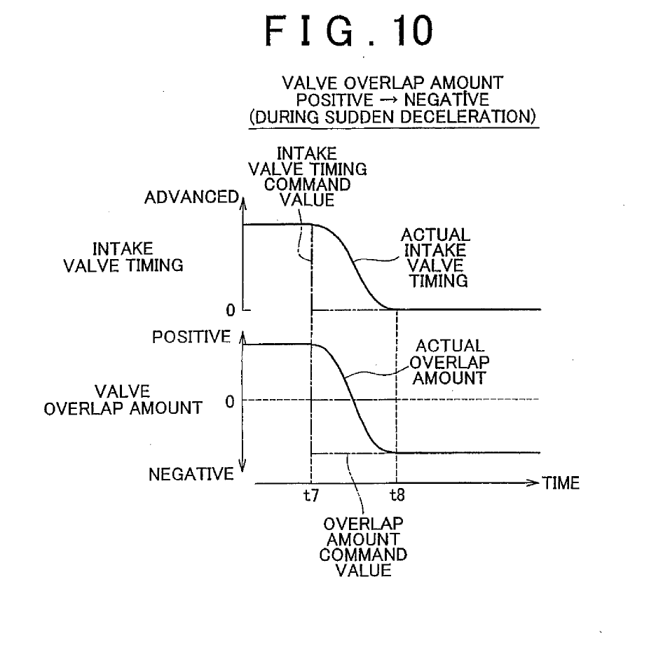

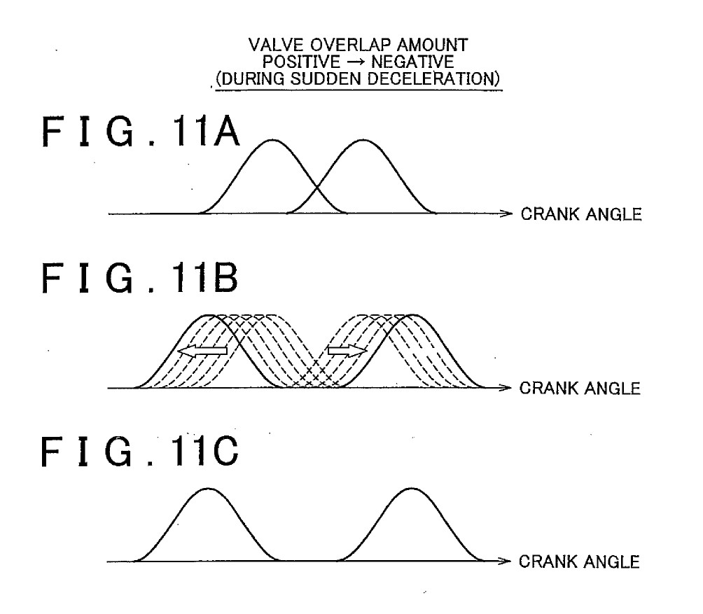

FIG. 10. Therefore, at this time, as shown in FIGS. 11A to 11C, the valve overlap amount is changed without being restricted at all. In this case, operation is not restricted in either the intake side variable valve timing mechanism 4 or the exhaust side variable valve timing mechanism 5 while the valve overlap amount is being changed, so the period of time between when that change starts (i.e., time t7 in FIG. 10) and ends (i.e., time t8 in FIG. 10) can be made as short as possible.

The reason for executing this control is as follows. That is, when the internal combustion engine 1 is stopped, the valve timing of the intake and exhaust valves needs to be placed in an initial state that can ensure good startability at low temperatures the next time the internal combustion engine 1 is started up. This initial state is a state in which the actual intake valve timing InVT is 0° and the actual overlap amount OL is at the initial value OLinit. Here, if operation of the exhaust side variable valve timing mechanism 5 is restricted as described above when the internal combustion engine 1 is stopped immediately after sudden deceleration, the change in the valve timing is delayed by that amount, which may result in the valve timing of the intake and exhaust valves being unable to be placed in the initial state before the internal combustion engine 1 stops. Therefore, in this example embodiment, during sudden deceleration, the valve timing of the intake and exhaust valves is changed to the initial state as quickly as possible without restricting the operation of the exhaust side variable valve timing mechanism 5.

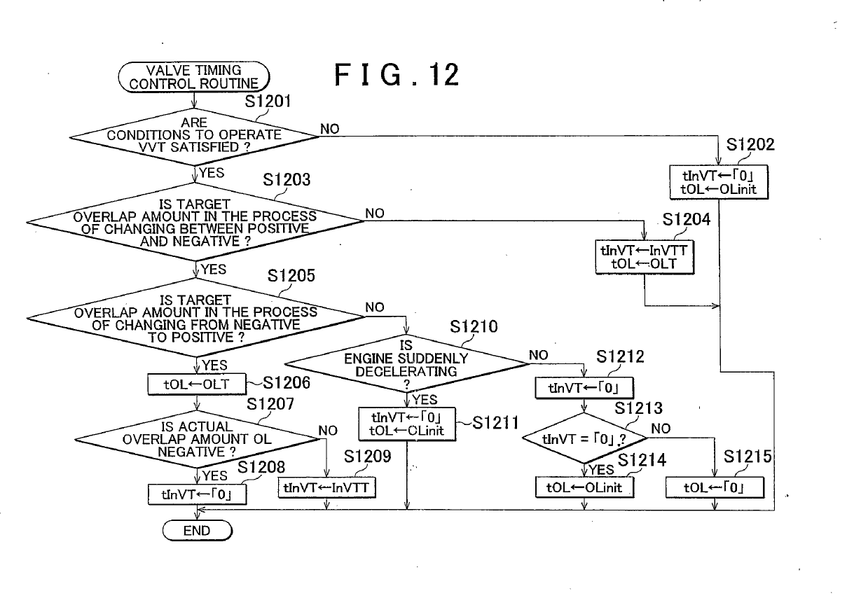

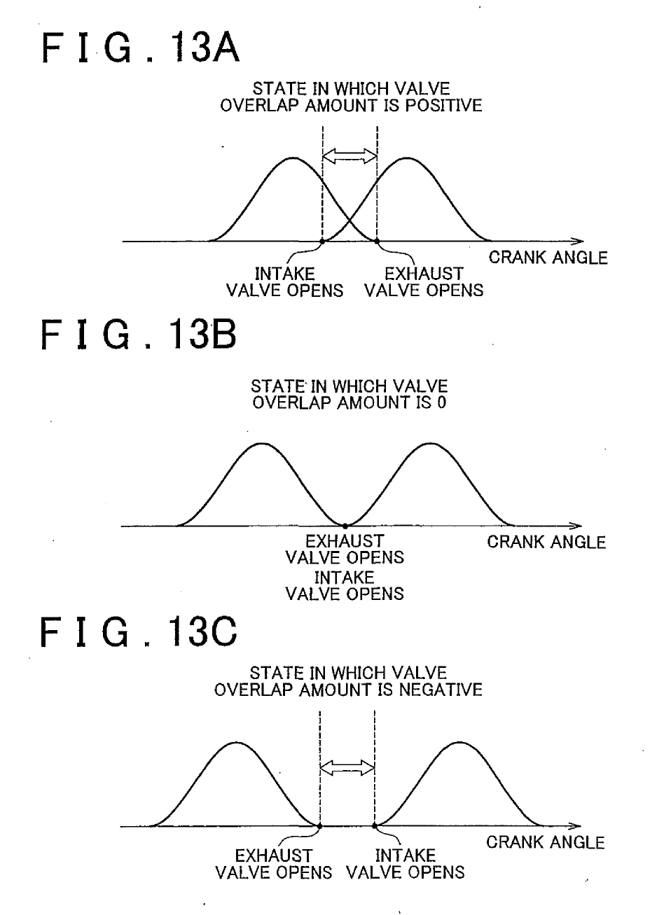

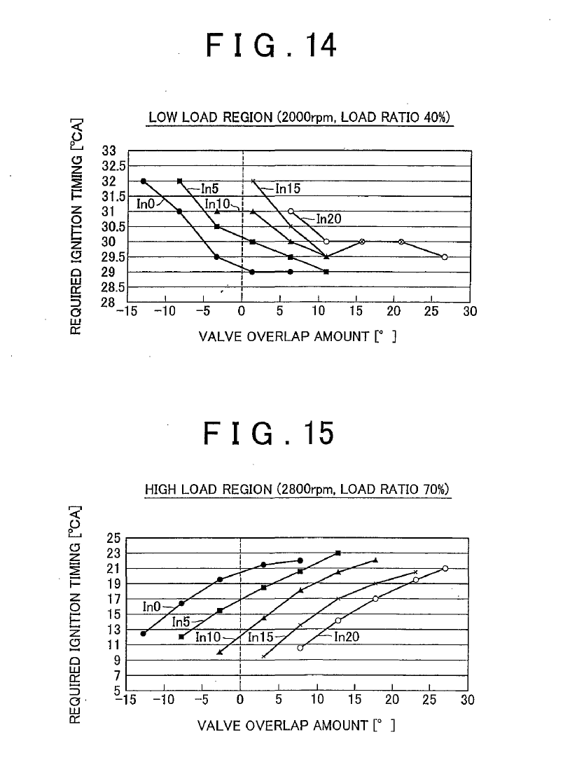

FIG. 12 is a flowchart illustrating a valve timing control routine used by the variable valve timing mechanism control apparatus of this example embodiment. This routine is repeatedly executed periodically by the ECU 10 while the internal combustion engine 1 is operating.

When the routine starts, the ECU 10 first determines in step 51201 whether conditions to operate the variable valve timing mechanism (VVT) (hereinafter these conditions will be referred to as “operating conditions”) are satisfied. These operating conditions are, for example, that startup of the internal combustion engine 1 be complete, that the engine be warmed up, and the like. If these operating conditions are not yet satisfied (i.e., NO in step S1201), the ECU 10 sets the intake variable valve command value tInVT to 0 and the overlap amount command value tOL to the initial value OLinit in step S1202, after which this cycle of the routine ends.

If, on the other hand, the operating conditions are satisfied (i.e., YES in step S1201), the ECU 10 determines in step S1203 whether the target overlap amount OLT is in the process of changing between positive and negative. If the target overlap amount OLT is not in the process of changing between positive and negative (i.e., NO in step S1203), the process proceeds on to step S1204. In step S1204, the ECU 10 sets the intake valve timing command value tInVT to the target intake valve timing InVTT calculated according to the operation map described above, and sets the overlap amount command value tOL to the target overlap amount OLT calculated also according to the operation map. Then this cycle of the routine ends.

If, on the other hand, the target overlap amount OLT is in the process of changing between positive and negative (i.e., YES in step S1203), the ECU 10 determines whether the target overlap amount OLT is in the process of changing from negative to positive in step S1205. If the target overlap amount OLT is in the process of changing from negative to positive, i.e., if the target overlap amount OLT is positive and the actual overlap amount OL is negative (i.e., YES in step S1205), then the process proceeds on to step S1206. If, on the other hand, the target overlap amount OLT is not in the process of changing from negative to positive, i.e., if the target overlap amount OLT is negative and the actual overlap amount OL is positive (i.e., NO in step S1205), then the process proceeds on to step S1210 instead.

If the process proceeds on to step S1206, the ECU 10 then sets the overlap amount command value tOL to the target overlap amount OLT calculated according to the operation map. Next, in step S1207, the ECU 10 determines whether the actual overlap amount OL is less than 0, and if so (i.e., YES in step S1207), sets the intake valve timing command value tInVT to 0° in step S1208. If, on the other hand, the actual overlap amount OL is equal to or greater than 0 (i.e., NO in step S1207), the ECU 10 sets the intake valve timing command value tInVT to the target intake valve timing InVTT calculated by the operation map. After the ECU 10 sets the intake valve timing command value tInVT in either step S1208 or step S1209, this cycle of the routine ends.

If, on the other hand, the process proceeds on to step S1210, the ECU 10 then determines whether the internal combustion engine 1 is suddenly decelerating. If the internal combustion engine 1 is suddenly decelerating (i.e., YES in step S1210), the ECU 10 sets the intake valve timing command value tInVT to 0° and sets the overlap amount command value tOL to the initial value OLinit in step S1211, after which this cycle of the routine ends.

If, on the other hand, the internal combustion engine 1 is not suddenly decelerating (i.e., NO in step S1210), the ECU 10 sets the intake valve timing command value tInVT to 0° in step 51212. Then in step S1213, the ECU 10 determines whether the actual intake valve timing InVT is 0. If so (i.e., YES in step S1213), the ECU 10 sets the overlap amount command value tOL to the initial value OLinit in step S1214. If not (i.e., NO in step S 1213), the ECU 10 sets the overlap amount command value tOL to 0 in step S1215. After the ECU 10 sets the overlap amount command value tOL in either step S1214 or step S1215 in this way, this cycle of the routine ends.

The variable valve timing mechanism control apparatus according to the example embodiment described above yields the following effects. In the foregoing example embodiment, when the valve overlap amount is negative, the valve timing of the intake valve is prohibited from changing and only the valve timing of the exhaust valve is changed. More specifically, when the valve overlap amount is changed from negative to positive, the valve timing of the intake valve is fixed and only the valve timing of the exhaust valve is changed until the valve overlap amount becomes 0. Then after the valve overlap amount reaches 0, the valve timing of the intake valve starts to be changed. Also, when the valve overlap amount is changed from positive to negative, the amount of change in the valve timing of the exhaust valve is restricted so that the valve overlap amount is kept at or above 0 until the valve timing of the intake valve has finished changing. That is, when the valve overlap amount is negative, the valve timing of the intake valve is fixed at 0° and only the valve timing of the exhaust valve is changed. Therefore, the required ignition timing will not change in a complex manner even when the valve overlap amount is negative. Thus, this example embodiment enables the ignition timing to be easily optimized even when the valve overlap amount is negative.

In this example embodiment, the restriction on the amount of change in the valve timing of the exhaust valve when the valve overlap amount is changing from positive to negative is cancelled when the internal combustion engine 1 is suddenly decelerating. Therefore, during sudden deceleration, the valve timing of the intake and exhaust valves can be placed in the initial state as quickly as possible. Accordingly, even if the internal combustion engine 1 is stopped after suddenly decelerating, for example, the valve timing of the intake and exhaust valves can be placed in an initial state that can ensure good startability at low temperatures, before the internal combustion engine 1 stops.

Incidentally, the foregoing example embodiment may also be modified as follows. For example, in the foregoing example embodiment, the variable valve timing mechanisms 4 and 5 are hydraulically operated mechanisms. However, the invention is not limited to this. That is, the variable valve timing mechanisms are not limited to being hydraulically operated variable valve timing mechanisms. For example, they may instead be electrically operated variable valve timing mechanisms or the like.

In the foregoing example embodiment, the restriction on the amount of change in the valve timing of the exhaust valve when the valve overlap amount is changing from positive to negative is cancelled when the internal combustion engine 1 is suddenly decelerating. However, when it is not necessary to place the valve timing of the intake and exhaust valves in the initial state before the internal combustion engine 1 stops, that restriction cancellation may be omitted (i.e., the restriction does not have to be cancelled). For example, in a case such as when the valve timing of the intake and exhaust valves is placed in the initial state by operating the variable valve timing mechanisms 4 and 5 after the internal combustion engine 1 stops, it is not necessary to cancel the restriction so that cancellation may be omitted.

In the foregoing example embodiment, the amount of change in the valve timing of the intake valve or the exhaust valve is restricted when the valve overlap amount changes from either positive to negative or from negative to positive. Alternatively, however, the amount of change in the valve timing of the intake valve or the exhaust valve may be restricted only when the valve overlap amount changes from positive to negative, or only when the valve overlap amount changes from negative to positive.

In the foregoing example embodiment, the valve timing of the intake valve is prohibited from changing and only the valve timing of the exhaust valve is changed in the region where the valve overlap amount is negative. Alternatively, however, the valve timing of the exhaust valve may be prohibited from changing and only the valve timing of the intake valve may be changed in the region where the valve overlap amount is negative. In this case as well, the required ignition timing will not change in a complex manner in the region where the valve overlap amount is negative so the ignition timing can easily be optimized even when the valve overlap amount is negative.

While the invention has been described with reference to what are considered to be preferred embodiments thereof, it is to be understood that the invention is not limited to the disclosed embodiments or constructions. On the contrary, the invention is intended to cover various modifications and equivalent arrangements. In addition, while the various elements of the disclosed invention are shown in various combinations and configurations, which are exemplary, other combinations and configurations, including more, less or only a single element, are also within the scope of the invention.

1. A variable valve timing mechanism control apparatus which enables a valve timing of an intake valve of an internal combustion engine and a valve timing of an exhaust valve of the internal combustion engine to be varied individually, comprising:
a controller which controls the variable valve timing mechanism in such a manner as to prohibit a change in the valve timing of one valve, from among the intake valve and the exhaust valve, and change the valve timing of the other valve, when a valve overlap amount is negative, wherein
the controller controls the variable valve timing mechanism in such a manner as to prohibit a change in the valve timing of the intake valve when the valve overlap amount is negative.

2. A variable valve timing mechanism control apparatus which enables a valve timing of an intake valve of an internal combustion engine and a valve timing of an exhaust valve of the internal combustion engine to be varied individually, comprising:
a controller which controls the variable valve timing mechanism in such a manner as to prohibit a change in the valve timing of one valve, from among the intake valve and the exhaust valve, and change the valve timing of the other valve, when a valve overlap amount is negative, wherein
the controller performs control which prohibits a change in the valve timing of one valve, from among the intake valve and the exhaust valve, and changes only the valve timing of the other valve during at least one of startup of the internal combustion engine and idling of the internal combustion engine.

3. The control apparatus according to claim 1, wherein the controller prohibits a change in the valve timing of the intake valve when the valve overlap amount is negative by restricting the amount of change in the valve timing of the intake valve when changing the valve overlap amount from negative to positive.

4. The control apparatus according to claim 1, wherein the controller fixes the valve timing of the intake valve and changes only the valve timing of the exhaust valve when the valve overlap amount is less than 0, and starts to change the valve timing of the intake valve when the valve overlap amount is equal to or greater than 0.

5. The control apparatus according to claim 1, wherein the controller prohibits a change in the valve timing of the intake valve when the valve overlap amount is negative by restricting the amount of change in the valve timing of the exhaust valve when changing the valve overlap amount from positive to negative.

6. The control apparatus according to claim 1, wherein the controller restricts the amount of change in the valve timing of the exhaust valve such that the valve overlap amount is kept equal to or greater than 0, until the change in the valve timing of the intake valve is complete.

7. The control apparatus according to claim 5, wherein the controller cancels the restriction on the amount of change in the valve timing of the exhaust valve when the internal combustion engine is suddenly decelerating.

8. The control apparatus according to claim 1, wherein the controller performs, on the variable valve timing mechanism, feedback control which sets a target intake valve timing and a target overlap amount, changes the valve timing of the intake valve to the target intake valve timing, and changes the valve timing of the exhaust valve such that the overlap amount comes to match the target overlap amount.

9. The control apparatus according to claim 8, wherein the controller calculates the target intake valve timing and the target overlap amount based on at least one of a speed of the internal combustion engine and an intake air amount of the internal combustion engine.

10. A variable valve timing mechanism control method which enables a valve timing of an intake valve of an internal combustion engine and a valve timing of an exhaust valve of the internal combustion engine to be varied individually, comprising:
prohibiting a change in the valve timing of one valve, from among the intake valve and the exhaust valve, and changing only the valve timing of the other valve when a valve overlap amount is negative; and
prohibiting a change in the valve timing of the intake valve when the valve overlap amount is negative.

11. A variable valve timing mechanism control apparatus which enables a valve timing of an intake valve of an internal combustion engine and a valve timing of an exhaust valve of the internal combustion engine to be varied individually, comprising:
a controller which: controls the variable valve timing mechanism in such a manner as to prohibit a change in the valve timing of one valve, from among the intake valve and the exhaust valve; and changes the valve timing of the other valve, when a valve overlap amount is negative;
and adjusts an ignition timing, at which fuel is ignited in the internal combustion engine, depending on the valve overlap amount.

12. The control apparatus according to claim 6, wherein the controller cancels the restriction on the amount of change in the valve timing of the exhaust valve when the internal combustion engine is suddenly decelerating.

13. The control apparatus according to claim 2, wherein the controller prohibits a change in the valve timing of the intake valve when the valve overlap amount is negative by restricting the amount of change in the valve timing of the intake valve when changing the valve overlap amount from negative to positive.

14. The control apparatus according to claim 2, wherein the controller fixes the valve timing of the intake valve and changes only the valve timing of the exhaust valve when the valve overlap amount is less than 0, and starts to change the valve timing of the intake valve when the valve overlap amount is equal to or greater than 0.

15. The control apparatus according to claim 2, wherein the controller prohibits a change in the valve timing of the intake valve when the valve overlap amount is negative by restricting the amount of change in the valve timing of the exhaust valve when changing the valve overlap amount from positive to negative.

16. The control apparatus according to claim 2, wherein the controller restricts the amount of change in the valve timing of the exhaust valve such that the valve overlap amount is kept equal to or greater than 0, until the, change in the valve timing of the intake valve is complete.

17. The control apparatus according to claim 15, wherein the controller cancels the restriction on the amount of change in the valve timing of the exhaust valve when the internal combustion engine is suddenly decelerating.

18. The control apparatus according to claim 16, wherein the controller cancels the restriction on the amount of change in the valve timing of the exhaust valve when the internal combustion engine is suddenly decelerating.

19. The control apparatus according to claim 2, wherein the controller performs, on the variable valve timing mechanism, feedback control which sets a target intake valve timing and a target overlap amount, changes the valve timing of the intake valve to the target intake valve timing, and changes the valve timing of the exhaust valve such that the overlap amount comes to match the target overlap amount.

20. The control apparatus according to claim 19, wherein the controller calculates the target intake valve timing and the target overlap amount based on at least one of a speed of the internal combustion engine and an intake air amount of the internal combustion engine.
